(19) United States
(12) Patent Application Publication
(10) Pub. No.: US 2009/0280452 A1
(43) Pub. Date: Nov. 12, 2009

(54) SINUS BUR HAVING AN EDGE WITHOUT SHARP POINTS

(76) Inventor: Leonard M. Garfinkel, Aventura, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/117,813

(22) Filed: May 9, 2008

(51) Int. Cl. A61C 3/02

(52) U.S. Cl. 433/165

(57) ABSTRACT

A dental bur used for boring pilot holes in the maxilla during endosseous dental implant surgery comprised of a rigid cylindrical body with a distal flat end having cutting blades and rounded edges. By using a bur having a flat cutting end face with rounded edges and not points, the pilot hole depth can be closer to the sinus cavity wall reducing the force required to infracture the remaining bond.

### BACKGROUND OF THE INVENTION

1. Field of the Invention

This invention relates to a sinus bur for drilling a pilot hole in die maxillary sinus bone for receiving an implant during endosseous dental implant surgery. The end of the sinus bur includes a cutting surface that uses a flat end with rounded edges that minimizes the risk of perforating the maxillary sinus cavity membrane.

2. Description of Related Art

Advancements in prosthodontics in recent years have lead to the widespread usage of endosseous dental implants. Endosseous dental implant surgery involves the replacement of an artificial tooth. One step in performing endosseous dental implant surgery initially involves drilling a pilot hole in the maxilla to a specific depth. Care is taken to avoid perforating the sinus membrane. The pilot hole drilling distance is crafted to achieve leaving a small layer of maxilla bone to be manually punctured without perforating the sinus membrane. The currently available burs have sharp points around the edges. Because of the danger of perforating the sinus membrane using such a bur, a sufficient amount of bone is left that requires a large manual force for the final manual puncturing with an osteotome tool.

Using the dental bur disclosed in this invention, a pilot hole depth can be achieved that leaves a small layer of maxillary bone left to be manually punctured without perforating the sinus membrane. The infracture can be performed without extensive manual banging that greatly reduces membrane perforations.

### SUMMARY OF THE INVENTION

A dental bur for creating a pilot hole in the maxilla comprising a rigid cylindrical body having a flat ended cutting bur with rounded edges. The end cutting surface can be a parallel blade design or a fluted design. In the parallel design, the cutting surfaces run parallel to one another. In a fluted design, each cutting flute can extend outward radially from the center of the end surface. Regardless of whether the cutting surface is of a parallel design or radial, the peripheral edges of the bur are rounded (not pointed). There are no sharp points around the peripheral edges of the bur.

The cylindrical bur body can include a conventional fastening end and one or more lateral annular grooves that are perpendicular to the longitudinal axis of the cylindrical bur body in specific pre-determined positions that are used as reference indicators for pilot hole depth so that the periodontist can determine the depth of the pilot hole as it is being bored.

The bur body may also have exterior longitudinal grooves extending from the cutting end that allows the removal of bone material from the pilot hole as it is being excavated. The dental bur includes a shaft connector for attachment to a rotary device that provides the rotation of the bur during a drilling operation.

Because the bur flat end peripheral edges are rounded if there were to be a break through of the sinus wall exposing the sinus cavity membrane, with the rounded edges on the flat end of the bur, the sinus membrane will not be perforated.

It is an object of the present invention to provide a dental bur that has a flat ended cutting burn with rounded edges.

It is another object of the invention to provide a dental bur with no sharp peripheral points for drilling pilot holes in the maxilla that allows the reduction of the thickness of bone to be infractured without additional risk of perforation of the sinus membrane.

In accordance with these and other objects which will become apparent hereinafter, the instant invention will now be described with particular reference to the accompanying drawings.

### BRIEF DESCRIPTION OF THE DRAWINGS

FIG. 1 is a perspective view of the cutting end of a dental bur in accordance with the present invention.

FIG. 2 is a schematic diagram showing the use of the cutting board described herein with respect to the maxillary sinus and bone.

### PREFERRED EMBODIMENT OF THE INVENTION

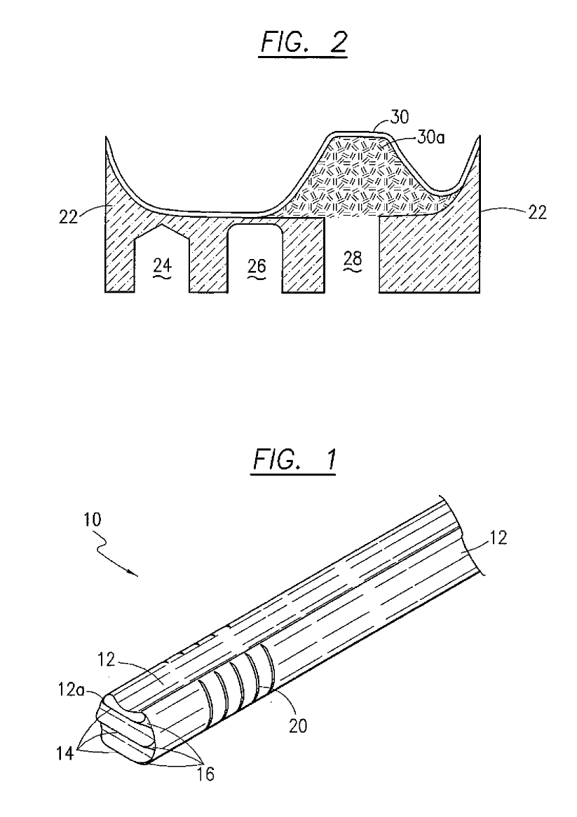

Referring now to the drawings and, in particular, FIG. 1, a dental bur 10 is shown which is partially cutaway and shows in perspective view the flat cutting end face of the dental bur 10. The dental bur has a metal rigid body 12 that is cylindrical and includes a conventional shaft (not shown) that attaches to a device that provides rotational motion for bur 10 for cutting. The flat end 12a of cylindrical body 12 includes a plurality of cutting blades 14 that are all parallel across the flat end face of the bur 10. At each end of the cutting blades 14, the periphery has been treated so that the ends are curved resulting in curved section 16 at the end of each cutting blade 14 peripherally around the entire end face 12a of bur body 12. Thus, all of the sharp blade points that may have previously been formed from blades 14 have been curved or rounded preventing any type of perforation of the sinus membrane during drilling of the pilot hole.

The dental bur 10 shown in FIG. 1 will be attached to a conventional source of rotational motion that provides the rotation of the bur for drilling pilot holes. Using the device shown in FIG. 1, a pilot hole can be drilled in the maxillary sinus. The pilot hole can reduce the thickness of bone to be manually infractured without the risk of perforating the sinus membrane.

Referring now to FIG. 2, a schematic diagram of the maxilla is shown with a series of exemplary pilot holes schematically represented such as 24, 26 and 28 that have been drawn as drilled in the maxilla 22. Also shown is the sinus membrane 30 and its material 30a above pilot hole 28 which has also been completely infractured. Using the dental bur shown in FIG. 1, the operator can initially use a conventional implant bur to create a pilot hole 24 that has a somewhat conical end face several millimeters above the sinus cavity leaving a significant amount of bone to be infractured for entry into the sinus cavity. Using the present dental bur shown in FIG. 1, the operator can continue in the pilot hole 26. Because of the curved edges of the cutting end face of the bur 12 in FIG. 1, significant more bone can be removed with a rectangular cross section of bone left to be infractured for access into the maxillary sinus cavity. Thus, the thickness of bone to be infractured as shown in pilot hole 26 is significantly reduced without additional risk of perforation because of the rounded edges of the cutting end face of the bur. The final infracture is shown in pilot hole 28 in which the membrane 30 has been significantly raised without perforation.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A dental bur for forming an osteotomy opening of a pre-determined depth in diameter sized to receive a dental implant comprising:
a rigid cylinder having a diameter sized to drill an osteotomy opening to a pre-determined depth, said cylindrical body having a flat end face that includes parallel blades for drilling bone tissue, the flat end face edges being rounded; and
a shaft integrally formed longitudinally along the longitudinal axis of said cylindrical drill body, said shaft being of a smaller diameter than the drill body and including a fastener portion for connecting the shaft to a device for rotating the drill.

2. A device as in claim 1, including:
said cylindrical drill body including at least one lateral peripheral recess used to gage the depth of the drill body during drilling.

3. A device as in claim 1, including:
at least one longitudinal channel for removing bone debris during a drilling operating disposed along of one side of said cylindrical drill body.

4. A device as in claim 1, wherein said bur body end face cutting blades are curved at a pre-determined curvature beginning from the outside surface of said body radially inward.

5. A bur for drilling an osteotomy cavity suitable for receiving a dental implant comprising:
a rigid cylindrical body of a first diameter that includes an extended longitudinal diameter shaft of a smaller diameter, said rigid cylindrical body having a flat end face having cutting blades curved and peripheral edges.
